(19) United States
(12) Patent Application Publication
(10) Pub. No.: US 2002/0169513 A1
(43) Pub. Date: Nov. 14, 2002

(54) Process for color management

(75) Inventors: William T. Sherrill, Charlotte, NC (US); Douglas A. Bynum, Mooresville, NC (US); Bradley W. McClanahan, Mooresville, NC (US); Niraj Agarwal, Charlotte, NC (US)

Correspondence Address: CLARIANT CORPORATION, INTELLECTUAL PROPERTY DEPARTMENT, 4000 MONROE ROAD, CHARLOTTE, NC, 28205, US

(73) Assignee: Clariant International, Ltd.

(21) Appl. No.: 09/883,647

(22) Filed: Jun. 18, 2001

Related U.S. Application Data
(60) Provisional application No. 60/289,978, filed on May 10, 2001.

(51) Int. Cl. G06F 19/00; G03G 15/01; C09D 201/00; C09D 101/00; C09D 4/00; C09F 1/00; C04B 2/10

(52) U.S. Cl. 700/109; 700/95; 700/110; 700/106; 106/500; 399/54; 106/741

(57) ABSTRACT

The present invention is directed to a method for color management by a retailer comprising the steps of: choosing an engineered color standard (ECS); communicating the ECS to a product vendor; having a product produced using the ECS; and controlling the product's color quality by comparing the ECS to the produced product. The ECS preferably comprises reflectance data and a dye specification.

### CROSS-REFERENCE TO RELATED APPLICATION

This application claims the benefit of Provisional Application No. 60/289,978 filed May 10, 2001 (unofficial).

### FIELD OF THE INVENTION

The invention is directed to a process for color management in manufactured goods.

### BACKGROUND OF THE INVENTION

Color is an extremely important element in the successful marketing and sales of most, if not all, retail articles. Managing color for acceptable shade, properties, and performance is challenging regardless of the substrate colored, for example, textiles, leather, plastics, paper, paint, ink, etc. Managing color can be especially formidable if a particular retail article is sourced from multiple vendors, as is the most likely case for articles with mass appeal, or if it contains different substrates or if it must be produced with “exact” or similar color on multiple substrates. The former situation (same article, multiple suppliers) is typical of a textile garment which, for example, could be supplied to a single retailer by 10 different vendors in 6 different countries on 3 different continents. The retailer, of course, expects the garments to look the “same” on his shelf, regardless of the vendor source. The latter situation (different substrates, same color) can be represented by a retailer selling coordinated components, for example, cotton towels, polyester curtains, vinyl shower curtains, wallpaper, plastic soap dishes, and other accessories for a bathroom or the components of an automobiles interior. Colors of the various coordinated components should behave similarly as viewing conditions change, such as, natural daylight versus artificial lighting, or viewing angle.

The textile/apparel industry, and its global supply web, provides a clear example of the importance of color management. Color is extremely important in the retail sales of textile products, for example, clothing. Retailers know that color is among the most important factors in determining whether the product is sold. To that end, retailers may employ designers to create new textile products. The designers, or others in the organization, may also supervise the production of those products. One element of both product creation and production is color management. Insuring that the color chosen by the designers is actually the color of the product produced for sale is extremely important. Insuring that the color chosen by the designer is the color of the product produced for sale, however, is not easy, particularly for products made for mass marketing efforts.

Referring to FIG. 1, a simplified, prior art process 10 for color management in textile production is illustrated. To simplify the following discussion, the textile product shall be referred to as a garment, it being understood that the textile product is not so limited. A retailer/designer 12 creates a new garment. The garment may include: a pattern; a fabric; and a color. The color selection process is tedious. See: Frugia, R. “Show Your True Colors—Today's Quality Control is Better Than Ever,” Quality Control, August 2000, pp. 36-38, incorporated herein by reference. The garment is submitted to a textile vendor 14. The textile vendor 14 may be: a cut and sew shop 16; a fabric mill 18; a dye house 20; or some combination thereof. The cut and sew shop 16 is responsible for transforming fabric, typically colored (dyed), etc., via the pattern, into the garment. Transforming refers to cutting the fabric and then sewing together the cut fabric to form the garment. The fabric mill 18 is responsible for weaving or knitting the fabric and may be responsible for coloring the fabric. The fabric mill 18, however, may not have the capability to dye the fabric, and accordingly, must rely upon the dye house 20. The dye house 20 is responsible for matching the color of the fabric requested by the retailer/designer 12 and dyeing the fabric for the fabric mill 18. To do this, the dye house 20 may use internal resources or consult external resources, such as a dye manufacturer 22. If the latter, the dye manufacturer 22 matches the color requested by the retailer/designer 12. Often, the match, by either the dye house 20 or dye manufacturer 22, is not perfect, but instead is “the best they can do” with the dyes they are familiar with, or the dyes typically available. This color match is then passed back up through the chain 14 to the retailer/designer 12 who is responsible for approving or disapproving the color match. This is a simple illustration of the prior art process.

FIG. 2 illustrates how the complexity of this process may escalate. In this illustration, it is assumed that the retailer/designer 12 plans to sell a coordinated outfit with a top and a bottom that have matching colors. The retailer/designer 12 may send the top to one cut and sew shop 16 and the bottom to another cut and sew shop 16. The cut and sew shop 16, in turn, solicits competitive bids for the colored fabric from two different fabric mills 18.

The fabric mills 18, in turn, approach two different dye houses 20 to solicit bids on the color and obtain color matches. The dye houses 20, in turn, contacts two dye manufacturers 22 to solicit information about color match and dye requirements. Therefore, it is possible that the top and bottom could have up to eight different dye recommendations, and none of these dye recommendations may be the same, resulting in undesirable metamerism and a strong probability of various fastness and performance anomalies.

FIG. 3 illustrates yet another level of detail regarding the traditional method of color management in the production of textiles. Here, the retailer/designer 30 is responsible for determining the classical shade design and concept of the garment. That shade design and concept are relayed to the retailer's color management team 32. The color management team 32 compares the color of the concept garment to existing commercially available standards 34, such as those produced by Pantone Inc. of Carlstadt, N.J., USA or Scotdic Colours Ltd. of New York City, N.Y., USA. If a suitable match exists, the garment is moved on to the textile vendor chain 14 discussed above. But, if no suitable match exists, the color management team 32 must commission the production of a suitable color sample 36. Such samples are produced by Pantone Inc. or Scotdic Colours Ltd. After a suitable match is produced, the garment is moved on to the textile vendor chain 14 discussed above.

With all of these independent color choices or decisions being made remote from the retailer/designer, each raises the possibility of further deviation from the designer's initial color choice. Each increases the likelihood that the color chosen by the retailer/designer will not be matched well. Those mistakes can have a detrimental impact on retail sales of the textile product. Moreover, the foregoing process can also be extremely time consuming which can also have a detrimental impact on retail sales.

This problem is recognized in the industry, but the solutions proposed have not eliminated the problem. See: Conrad, A., “In Living Color,” Women's Wear Daily, Dec. 27, 2000, p. 10, and Powers, D., “Target's Color Story,” Women's Wear Daily, Feb. 1, 2001, both incorporated herein by reference.

Accordingly, there is a need to improve the color management process.

### SUMMARY OF THE INVENTION

The present invention is directed to a method for color management by a retailer comprising the steps of: choosing an engineered color standard (ECS); communicating the ECS to a textile vendor; having a textile produced using the ECS; and controlling the textile's color quality by comparing the ECS to the produced textile. The ECS preferably comprises reflectance data and a dye specification.

### DESCRIPTION OF THE DRAWINGS

For the purpose of illustrating the invention, there is shown in the drawings a form which is presently preferred; it being understood, however, that this invention is not limited to the precise arrangement and instrumentalities shown.

FIG. 1 is a schematic representation of a prior art process for color management in the production of textiles.

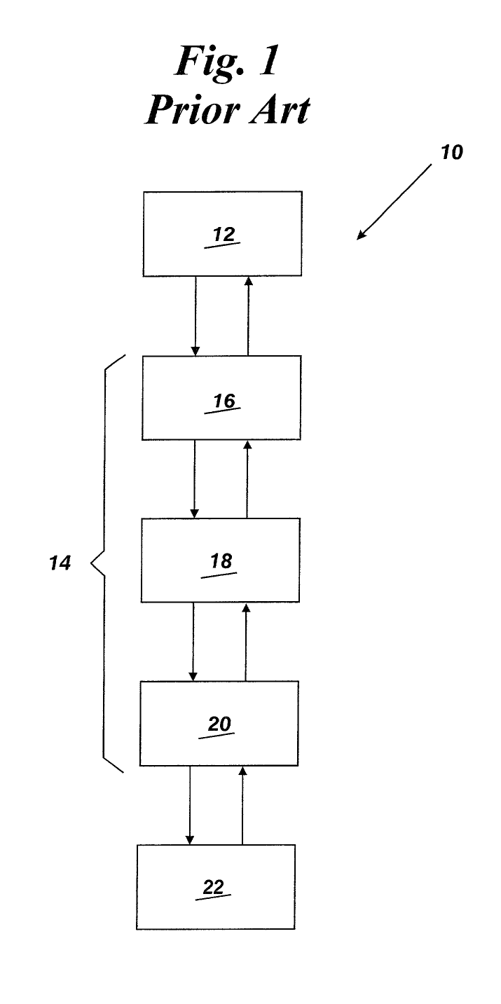

FIG. 2 is a schematic representation of a prior art process for color management in a production of a textile.

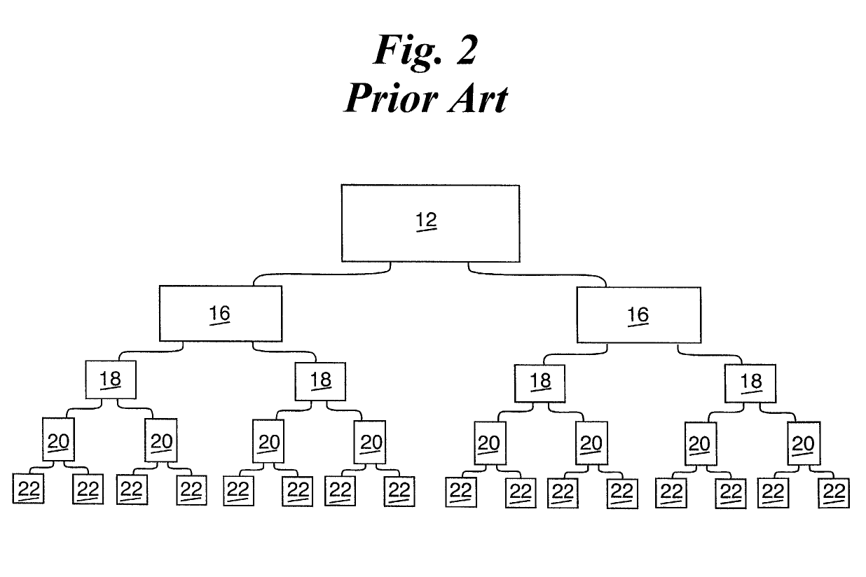

FIG. 3 is a schematic representation of a prior art process for color management in the production of textiles.

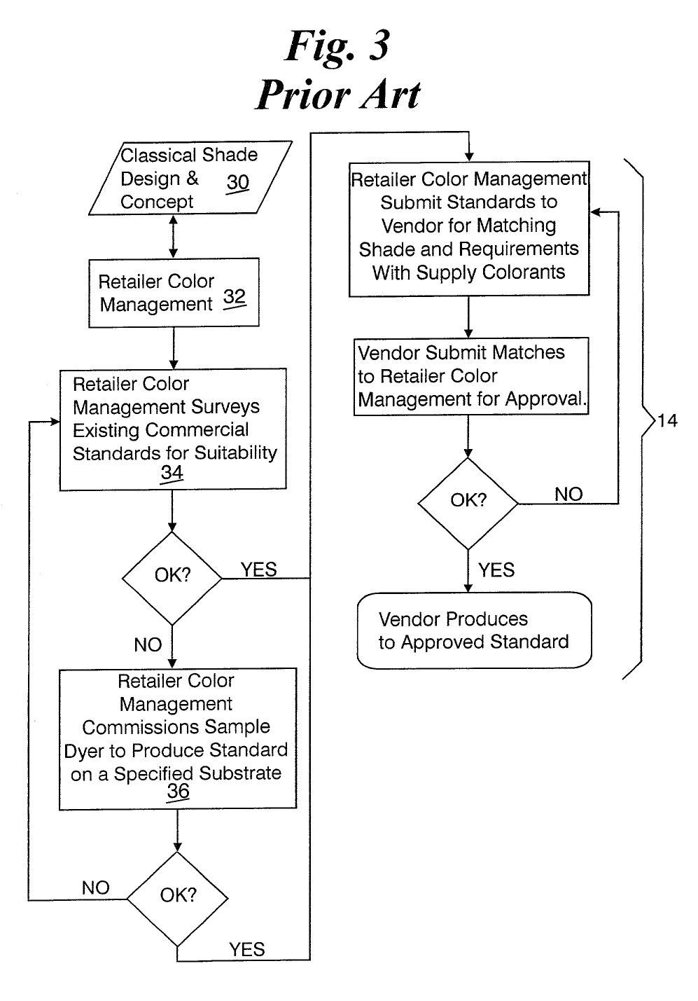

FIG. 4 is a schematic representation of the instant invention.

FIG. 5 is an illustration of the printed form of an ECS.

FIG. 6 is a schematic representation of the instant invention.

FIG. 7 is a schematic illustration of a swatch.

### DETAILED DESCRIPTION OF THE INVENTION

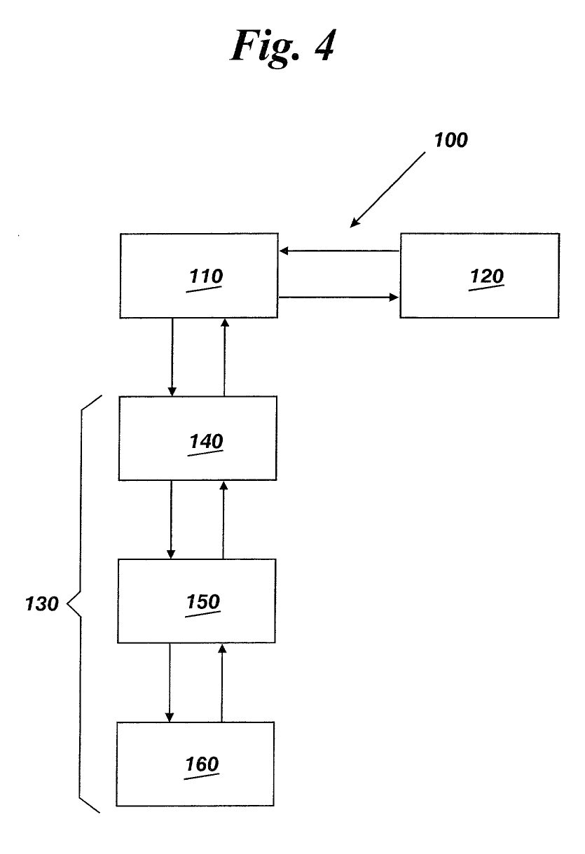

Referring to the drawings wherein like numerals indicate like elements, there is shown in FIG. 4 a schematic representation of the present invention, a method for color management 100 by a retailer. A retailer refers to, for example, one who directly sells to consumers (e.g., a chain store (e.g., Target, Wal-Mart, K-Mart, Sears, Old Navy, GAP), or automobile manufacturer (e.g., Ford, GMC, Chrysler)), or one who sells coordinated products to a direct seller to consumers (e.g., clothing or housewares designer, such as Laura Ashley, Martha Stewart, or the like), or anyone who could take advantage of the present invention.

The present invention, for ease of explanation, will be discussed with reference to textile production, e.g., garment manufacture, it being understood that the invention is not so limited.

In FIG. 4, a retailer/designer 110 creates a new textile product, for example, a garment. The garment may include: a pattern; a fabric; and a color. The retailer/designer 110 consults with an engineered color standard provider 120. The provider 120 assists the retailer/designer 1 10 with the color management process by, among other things, providing engineered color palettes for speeding color selection and development, and engineered color standards. The provider 120 matches the color of the garment and provides an engineered color standard (ECS), described in detail below, to the retailer/designer 110. The retailer/designer 110 then communicates with textile vendor 130. This communication may be for the purpose of soliciting a bid, or placing an order, for the production of the garment. The communication may consist of information about the garment, such as the pattern, the fabric, and the color. The most effective way of communicating information about color is with the ECS. The textile vendor 130 may consist of: a cut and sew shop 140; a fabric mill 150; a dye house 160; or combinations thereof. By use of the ECS, the retailer/designer 110 insures that the color of the garment for which the retailer/designer 110 is soliciting bids, or placing orders, will be the same among the various textile vendors used. After the retailer/designer 110 has chosen the specific textile vendor 130 to produce the garment, the retailer/designer 110 may use the ECS as the control by which to measure the quality of the color of the garment produced by the textile vendor 130.

Matching the garment color for the purpose of providing an engineered color standard is preferably accomplished by use of color matching software. Such software is known. Commercially available color matching software includes, for example, MATCHWIZARD™ PRO color matching software available from Clariant Corporation of Charlotte, N.C., USA; ProPalette® software from Gretag Macbeth, New Windsor, N.Y.; and ColorTools® software from DataColor Corporation, Lawrenceville, N.J.

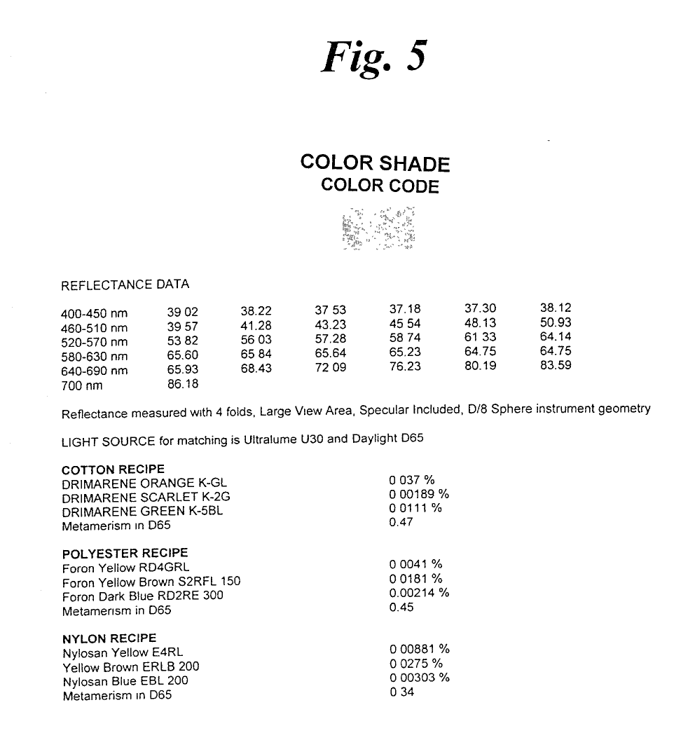

The engineered color standard (ECS) preferably is reflectance data and a dye specification. See FIG. 5. The dye specification may include a dyestuff formula and a recommended dyeing process. The dyestuff formula is the specific dyestuffs and the blend ratio necessary to obtain, for example, a specific color shade and a specific fastness on a particular substrate. Use of the same dyestuff formula among various suppliers will, among other things, eliminate metameric color matches, reduce shade variations, and improve colorfastness variation. The ECS may also include a finish (e.g., finish chemical formula) and a recommended finishing process. Additionally,the ECS may include preparation chemicals, preparation chemical formulas and recommended preparation process. Dye specification could alternatively refer to a pigment specification depending upon the substrate. The ECS may also include a swatch, discussed in greater detail below.

Communication of the ECS from the retailer/designer 110 to the textile vendor 130 is preferably by electronic media, e.g., via the Internet. Such communication is quick and secure, and may be linked directly with appropriate software for controlling or managing the color in the textile production. Alternatively, communicating may include: physical delivery; posting to a website; or combinations of the foregoing.

Control of color quality is preferably accomplished by use of color matching software (electronically inspecting). Such software is known. Commercially available color matching software includes: MATCHWIZARD™ PRO software from Clariant Corporation of Charlotte, N.C.; ProPalette® software from Gretag Macbeth, New Windsor, N.Y.; and ColorTools® software from DataColor Corporation, Lawrenceville, N.J. Alternatively, control may be accomplished by visually inspecting, visually inspecting under a single light source, visually inspecting under multiple light sources, or combinations of the foregoing.

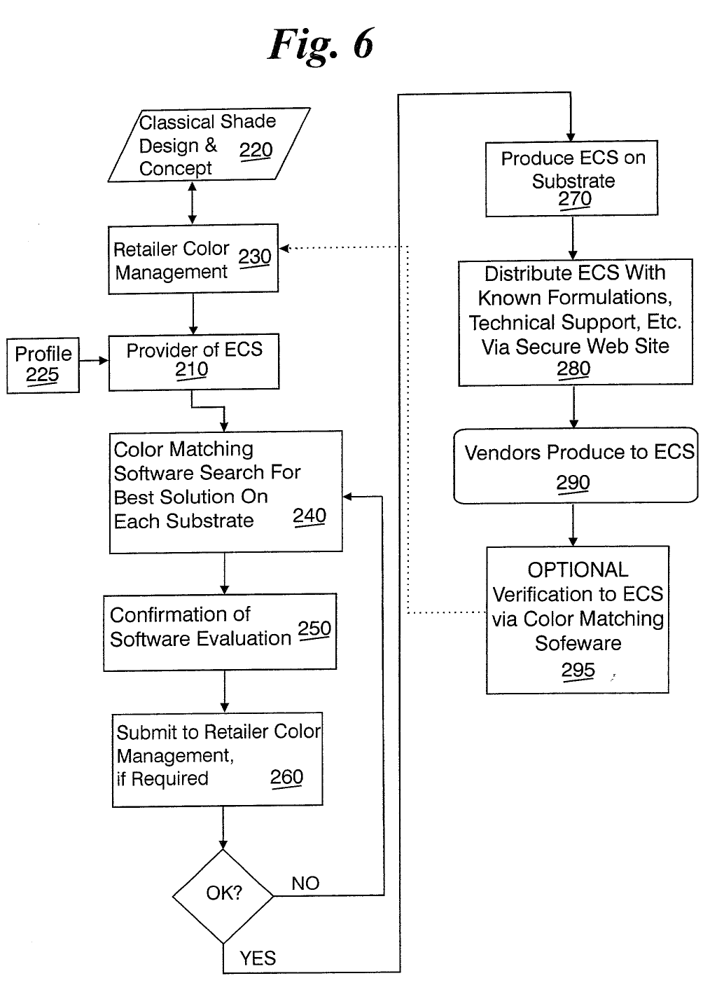

Referring to FIG. 6, the foregoing method is explained in another level of detail. Method 200 is built around an ECS provider 210. ECS provider 210 assists a retailer/designer 220 with the color management process by, among other things, providing engineered color palettes for speeding color selection and development, engineered color standards (ECS), providing color quality management services, and other related color, or finishing, advice. The retailer/designer 220 creates a color for the garment. See: Frugia, R., “Show Your True Colors1—Today's Quality Control is Better Than Ever,” Quality Digest, August, 2000, pp. 36-38, incorporated herein by reference. The retailer/designer 220 may refer that color to the retailer/designer's color management team 230. The color management team 230 refers the color to the ECS provider 210. The ECS provider 210 may have a retailer/designer profile 215, i.e., considerations necessary to facilitate ECS recommendation that are tailored to the specific retailer/designer 220. The profile 225 identifies “acceptable tradeoffs,” e.g., cost versus fastness, color versus light source. Provider 210, preferably utilizing color matching software, matches 240 the color and prepares the ECS. The match may, preferably, be confirmed 250 with an alternate technique (e.g., actual dyeing). Thereafter, the ECS is submitted 260 to team 230 for approval. Upon approval, the provider 210 generates 270 the ECS, e.g., posts the ECS to a secure website, or communicates the ECS to the retailer/designer 220. The ECS is communicated 280 to the textile vendor. The vendor produces 290 the product. Product quality, e.g., color or finish quality, may be controlled 295 against the ECS.

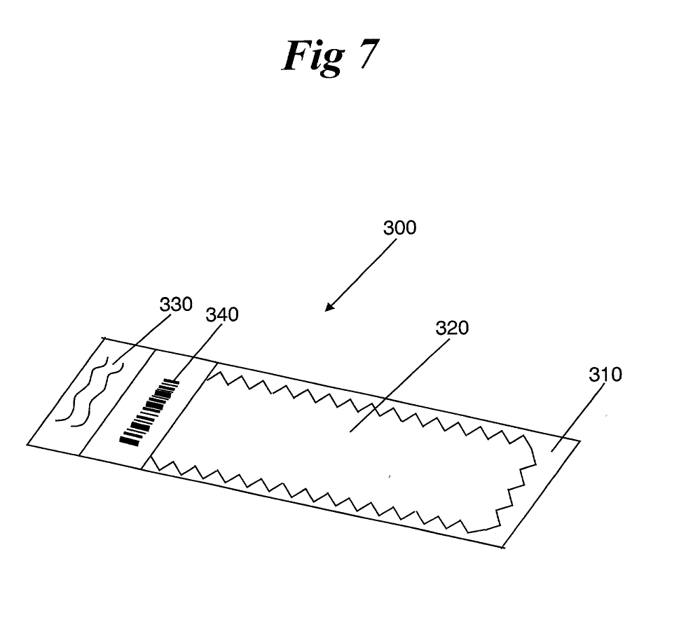

Referring to FIG. 7, a swatch 300 is illustrated. Swatch 300 may be included as a part of the ECS. Swatch 300 comprises a carrier 310 and colored fabric 320. Carrier 310 preferably is made of a stout paper stock which is folded to sandwich and secure fabric 320. Fabric 320 is colored (e.g., dyed) to match the ECS. Additionally, fabric 320 may be finished. Information 330 (e.g., reflectance data, dye specification(s), finish(s)) about the ECS may be printed on swatch 300. Alternatively, encrypted information 340, e.g., the foregoing information 330, may be contained in bar code. Swatch 300 physically illustrates the color of the ECS.

The present invention may be embodied in other specific forms without departing from the spirit or essential attributes thereof, and, accordingly, reference should be made to the appended claims, rather than to the foregoing specification, as indicating the scope of the invention.

1. A method for color management by a retailer comprising the steps of:
choosing an engineered color standard (ECS);
communicating the ECS to a product vendor;
having a product produced using the ECS; and
controlling a product's color quality by comparing the ECS to the product.

2. A method for color management by a retailer comprising the steps of:
choosing an engineered color standard (ECS), the ECS comprising a component, the component being reflectance data and a dye specification;
communicating the ECS to a product vendor;
having a product produced using the ECS; and
controlling a color quality of the product by comparing the ECS to the product.

3. The method of claim 1 wherein the ECS further comprises a component being selected from the group consisting of dyestuff, dye specification, dyeing procedures, finishes, finishing procedures, preparation chemicals, preparation processes and combinations thereof.

4. The method of claim 1 wherein choosing an engineered color standard further comprises:
designing a product having a color,
communicating the color to a provider of engineered color standards, and
analyzing the color to obtain the ECS.

5. The method of claim 4 wherein analyzing the color further comprises the step of using computer aided color matching techniques.

6. The method of claim 1 wherein communicating the ECS to the product vendor being selected from the group consisting of: physically sending the ECS, electronically sending the ECS, posting the ECS at a website, and combinations thereof.

7. The method of claim 1 wherein controlling the product's color by comparing the ECS to the produced product being selected from the group consisting of: visually inspecting, visually inspecting under a single light source, visually inspecting under multiple light sources, electronically inspecting, and combinations thereof.

8. The method of claim 1 wherein the product vendor is a textile vendor selected from the group consisting of: a cut and sew shop, a fabric mill, a dye house, or combinations of both.

9. A method for color management by a retailer comprising the steps of:
providing an engineered color standard (ECS), the ECS comprising reflectance data, and a dyestuff formula;
communicating the ECS to a product vendor;
having a product produced using the ECS; and
controlling a product's color quality by comparing the ECS to the product.

10. The method of claim 9 wherein the ECS further comprises a component being selected from the group consisting of dyestuff, dyeing procedures, finishes, finishing procedures, preparation chemicals, preparation processes and combinations thereof.

11. The method of claim 9 wherein providing an engineered color standard further comprises:
receiving a product having the color from a retailer;
analyzing the color to obtain the ECS; and
communicating the ECS to the retailer.

12. The method of claim 11 wherein analyzing the color comprises the step of using computer aided color matching techniques.

13. The method of claim 9 wherein communicating the ECS to the product vendor being selected from the group consisting of: physically sending the ECS, electronically sending the ECS, posting the ECS at a website, and combinations thereof.

14. The method of claim 9 wherein controlling the product's color by comparing the ECS to the produced product being selected from the group consisting of: visually inspecting, visually inspecting under a single light source, visually inspecting under multiple light sources, electronically inspecting, and combinations thereof.

15. The method of claim 9 wherein the product vendor is a textile vendor selected from the group consisting of: a cut and sew shop, a fabric mill, a dye house, or combinations of both.

16. The method of claim 11 wherein communicating the ECS to the retailer being selected from the group consisting of: physically sending the ECS, electronically sending the ECS, posting the ECS at a website, and combinations thereof.

17. A method for color management comprising the steps of:
receiving a product having a color from a retailer;
analyzing the color of the product to obtain an engineered color standard (ECS), the ECS comprising reflectance data; and
communicating the ECS to the retailer.

18. The method of claim 17 wherein the requestor being selected from the group consisting of retailers, designers, and combinations thereof, and the requestor not being selected from the group of cut and sew shops, fabric mills, dye house, and combinations thereof.

19. The method of claim 17 wherein the ECS further comprises a component being selected from the group consisting of dyestuff, dyeing procedures, finishes, finishing procedures, preparation chemicals, preparation processes and combinations thereof.

20. The method of claim 17 wherein analyzing the color shade comprises the step of using computer aided color matching techniques.

21. The method of claim 17 wherein communicating the ECS to the product vendor being selected from the group consisting of: physically sending the ECS, electronically sending the ECS, posting the ECS at a website, and combinations thereof.

22. A swatch for use in a color management process comprising: a colored substrate; a backing, the substrate being affixed to the backing;
reflectance data being on the backing; and a dye specification being on the backing.

23. The swatch of claim 22 further comprising a bar code on the backing.

24. The method of claim 2 wherein the ECS further comprises a component being selected from the group consisting of dyestuff, dye specification, dyeing procedures, finishes, finishing procedures, preparation chemicals, preparation processes and combinations thereof.

25. The method of claim 2 wherein choosing an engineered color standard further comprises:
designing a product having a color,
communicating the color to a provider of engineered color standards, and
analyzing the color to obtain the ECS.

26. The method of claim 25 wherein analyzing the color further comprises the step of using computer aided color matching techniques.

27. The method of claim 2 wherein communicating the ECS to the product vendor being selected from the group consisting of: physically sending the ECS, electronically sending the ECS, posting the ECS at a website, and combinations thereof.

28. The method of claim 2 wherein controlling the product's color by comparing the ECS to the produced product being selected from the group consisting of: visually inspecting, visually inspecting under a single light source, visually inspecting under multiple light sources, electronically inspecting, and combinations thereof.

29. The method of claim 2 wherein the product vendor is a textile vendor selected from the group consisting of: a cut and sew shop, a fabric mill, a dye house, or combinations of both.
